(19) United States
(12) Patent Application Publication
(10) Pub. No.: US 2026/0358154 A1
(43) Pub. Date: Nov. 12, 2026

(54) System for estimating a physical magnitude and associated method

(71) Applicant: THALES, Meudon (FR)

(72) Inventors: Fateh KAAKAI, PALAISEAU CEDEX (FR); Jean-Marc GUAUS, TOULOUSE CEDEX 1 (FR); Geoffrey DELHOMME, MERIGNAC (FR)

(21) Appl. No.: 19/674,125

(22) Filed: May 12, 2026

(30) Foreign Application Priority Data
May 12, 2025 (FR) 25 05006

(51) Int. Cl. G01D 21/00

(52) U.S. Cl. CPC G01D 21/00

(57) ABSTRACT

A system for estimating a physical magnitude including several devices for estimating the physical magnitude, each estimation device including an analysis module, each analysis module being able to analyze the consistency of values derived from predictions obtained by applying at least two estimation models to data acquired by a detection device, one estimation model being an update of another estimation model, to obtain a value representative of consistency between the predictions, and a coordination system able to apply an aggregation function to the values representative of consistency between the predictions to obtain an aggregated value and able to deduce an estimation of the physical magnitude to be estimated from the aggregated value.

### REFERENCE TO RELATED APPLICATIONS

This application is a U.S. non-provisional application claiming the benefit of French Patent Application No. 25 05006 filed on May 12, 2025, the contents of which are incorporated herein by reference in their entirety.

### TECHNICAL FIELD OF THE INVENTION

The present invention relates to a system for estimating a physical magnitude. It also relates to an associated estimation method.

### BACKGROUND OF THE INVENTION

Artificial intelligence technologies are increasingly used to develop models resulting from data-driven machine learning in critical systems.

These models are notably estimation models able to provide an estimated value of the physical magnitude over a predefined domain of use.

The predefined domain of use is, by definition, the set of operating conditions in which the estimation model is specifically designed to operate, including, but not limited to, environmental, geographical and temporal restrictions.

The predefined domain of use is often referred to by the abbreviation ODD, which refers to the English name “operational design domain”.

The estimation model is thus trained on data reflecting the domain of use by assuming that the data that the estimation model will process in operation will always be part of the domain of use.

However, it frequently happens that the situations (in other words, the data) encountered in practice by the estimation model are different from those used to train it.

This leads the estimation model to be confronted with changes over time in the distribution of the data (more commonly referred to by the English term “data drift”), to changes in the relationship between inputs and output(s) of the estimation model (more commonly referred to by the English term “concept drift”) or even data that are not included in the predefined domain of use (abnormal data or “outliers” by reference to the corresponding English name).

The performance of the estimation model is affected by this, which is resolved by carrying out frequent updates of the estimation model, for example every quarter, every month, every week, every day or after each operational mission using the estimation model. These updates are to be carried out even in the presence of restricted access to the data.

For these updates, it is known to use incremental learning and qualification techniques. This involves retraining on small increments of datasets including a selection of new data and old data. This allows to avoid using a complete dataset that is too large to carry out the update of the estimation model.

However, in the context of frequent and rapid updates of an estimation model, it is common for the new version to include problems (more often called bugs) due to the fact that the design, verification and validation activities of the estimation model are insufficient because of the constraints imposed by incremental development and qualification. Lack of time, an insufficient volume of new training and test data, or lack of access to such data are examples of such constraints.

In particular, catastrophic forgetting of problems may occur. This corresponds to a situation in which the estimation model loses previously acquired knowledge during the incremental update. This is not acceptable for a critical system which implies ensuring the safe maintenance of certain functionalities.

There is therefore a need for a device for estimating a physical magnitude allowing to operate an estimation model updated incrementally under constraints (reduced time, reduced data volume, reduced access to data) with increased safety, notably for use of the estimation device in a critical system.

### SUMMARY OF THE INVENTION

For this purpose, the description has as its object a device for estimating a physical magnitude, the estimation device including:
a first estimation module, the first estimation module including:
a first receiving unit able to receive data acquired by a detection device, and
a first calculation unit able to apply a first estimation model to the data received by the first receiving unit to obtain a first prediction of the physical magnitude to be estimated,
a second estimation module, the second estimation module including:
a second receiving unit able to receive data acquired by a detection device, and
a second calculation unit able to apply a second estimation model to the data received by the second receiving unit to obtain a second prediction of the physical magnitude to be estimated, the second estimation model being an update of the first estimation model, and
an analysis module, the analysis module being able to analyze the consistency of values derived from the first prediction and the second prediction and to deduce from the consistency analysis an estimation of the physical magnitude to be estimated for the estimation device.

According to other advantageous aspects, the estimation device includes one or more of the following features, taken in isolation or in all technically possible combinations:
the value derived from the first prediction and the value derived from the second prediction are inconsistent, the analysis module is able to deduce that the value of the estimation of the physical magnitude is the value derived from the first prediction;
the value derived from the first prediction and the value derived from the second prediction are consistent, the analysis module being able to deduce that the value of the estimation of the physical magnitude is the value derived from the second prediction;
the first estimation module includes a first determination unit for a first value representative of the confidence in the prediction of the first calculation unit and the second estimation module includes a second determination unit for a second value representative of the confidence in the prediction of the second calculation unit, the values derived from the first prediction and the second prediction, of which the analysis module verifies the consistency, being obtained from the first prediction, from the second prediction, of the first value representative of the confidence in the prediction of the first calculation unit and the second value representative of the confidence in the prediction of the second calculation unit;
the analysis module further includes:
a first consolidation unit able to obtain a first consolidated prediction from the first prediction (P_{N}) as a function of a first confidence criterion applied to the first value representative of the confidence in the prediction of the first calculation unit, and
a second consolidation unit able to obtain a second consolidated prediction from the second prediction (P_{N}) as a function of a second confidence criterion applied to the second value representative of the confidence in the prediction of the second calculation unit, the values derived from the first prediction and the second prediction, the consistency of which is verified by the analysis module, being respectively the first consolidated prediction and the second consolidated prediction;
the first confidence criterion is a comparison of the first value representative of the confidence in the prediction of the first calculation unit with a first predefined threshold and the second confidence criterion is a comparison of the second value representative of the confidence in the prediction of the second calculation unit with a second predefined threshold;
the estimation device further includes a warning module, the warning module being able to emit an alert in the presence of multiple inconsistencies between the values, derived from the first prediction and the second prediction, the consistency of which is verified by the analysis module;
the warning module is able to accumulate the results of the consistency analyses and to emit the alert when the number of inconsistencies for a number of consistency analysis results carried out by the analysis module is greater than or equal to a threshold;
the data acquired by the detection device are images or audio signals;
the physical magnitude characterizes the environment of the detection device, the physical magnitude being in particular the temperature or the presence and/or identification of an object in this environment;
the physical magnitude is a magnitude relating to a means of transport including the detection device, in particular a magnitude giving the trajectory of the means of transport;
the estimation device includes a sending module suitable for sending the estimate of the physical magnitude to be estimated to a control module, the control module being suitable for controlling a physical device as a function of the estimate of the physical magnitude to be estimated, in particular for modifying the operation of the physical device;
the physical device is a means of transport, in particular an aircraft;

The description also has as its object a device for estimating a physical magnitude, the estimation device including:
a first estimation module, the first estimation module including:
a first receiving unit able to receive data acquired by a detection device, and
a first calculation unit able to apply a first estimation model to the data received by the first receiving unit to obtain a first prediction of the physical magnitude to be estimated,
a second estimation module, the second estimation module including:
a second receiving unit able to receive data acquired by a detection device, and
a second calculation unit able to apply a second estimation model to the data received by the second receiving unit to obtain a second prediction of the physical magnitude to be estimated, the second estimation model being a first update of the first estimation model,
a third estimation module, the third estimation module including:
a third receiving unit able to receive data acquired by a detection device, and
a third calculation unit able to apply a third estimation model to the data received by the third receiving unit (66) to obtain a third prediction of the physical magnitude to be estimated, the third estimation model being a second update of the first estimation model,
an analysis module, the analysis module being able to receive each prediction and to obtain an estimation of the physical magnitude to be estimated for the estimation device from the received predictions, and
an inhibition module, the inhibition module being able to inhibit reception by the analysis module of the prediction of at least one estimation module from among the first estimation module, the second estimation module and the third estimation module.

According to other advantageous aspects, the estimation device includes one or more of the following features, taken in isolation or according to all the technically possible combinations:
the inhibition module includes an inhibition unit for each estimation module the inhibition module of which is able to inhibit reception of the prediction by the analysis module;
each inhibition unit includes at least one switch presenting an open position in which reception of the prediction by the analysis module is inhibited and a closed position in which reception of the prediction by the analysis module is not inhibited;
the inhibition module is able to inhibit only the reception of the prediction from the second estimation module and the third estimation module;
the inhibition module presents a first state in which only reception of the prediction from the second estimation module is inhibited and a second state in which only reception of the prediction from the third estimation module is inhibited, the estimation device further including a control module, the control module being able to control the state of the inhibition module;
the control module is able to cause the implementation of an operation of loading the third estimation model onto the third calculation unit and to control the inhibition module so that the inhibition module is in the first state when the loading operation has not been implemented and in the second state when the loading operation has taken place;
the analysis module is able to analyze the consistency of values derived from the received predictions and to deduce from the consistency analysis an estimation of the physical magnitude to be estimated for the estimation device;
the predictions received by the analysis module are the first prediction and one prediction from among the second prediction and the third prediction;
the data acquired by the detection device are images or audio signals;
the physical magnitude characterizes the environment of the detection device, the physical magnitude being in particular the temperature or the presence and/or identification of an object in this environment;
the physical magnitude is a magnitude relating to a means of transport including the detection device, in particular a magnitude giving the trajectory of the means of transport;
the estimation device includes a sending module suitable for sending the estimate of the physical magnitude to be estimated to a control module, the control module being suitable for controlling a physical device as a function of the estimate of the physical magnitude to be estimated, in particular for modifying the operation of the physical device;
the physical device is a means of transport, in particular an aircraft.

The description also has as its object a system for estimating a physical magnitude, the estimation system including:
several devices for estimating the physical magnitude, each estimation device including an analysis module, each analysis module being able to analyze the consistency of values derived from predictions obtained by applying at least two estimation models to data acquired by a detection device, one estimation model being an update of another estimation model, to obtain a value representative of the consistency between the predictions, and
a coordination system able to apply an aggregation function to the values representative of the consistency between the predictions to obtain an aggregated value and able to deduce an estimation of the physical magnitude to be estimated from the aggregated value.

According to other advantageous aspects, the estimation device includes one or more of the following features, taken in isolation or according to all the technically possible combinations:
each device for estimating the physical magnitude includes a communication system and the coordination system includes a communication unit, the communication unit of the coordination system being able to communicate the deduced estimation to each communication system of an estimation device, the estimation of the physical magnitude by each estimation device being the estimation deduced by the coordination system;
the aggregation function is a majority vote;
for each analysis module, the values derived from each prediction are obtained from the value of the prediction and from a value representative of the confidence in the prediction;
each estimation device includes, for each prediction, a consolidation unit able to obtain a consolidated prediction from the prediction as a function of a respective confidence criterion applied to the value representative of the confidence in the prediction, the values derived from each prediction of which the analysis module, checks the consistency being respectively the consolidated prediction;
each estimation device further includes a warning module able to obtain a value representative of the temporal evolution of the results of the consistency analysis, the values representative of the consistency between the predictions being the values representative of the temporal evolution;
each estimation device further includes:
a third estimation module, the third estimation module including:
a third receiving unit able to receive data acquired by a detection device, and
a third calculation unit able to apply a third estimation model to the data received by the third receiving unit to obtain a third prediction of the physical magnitude to be estimated, the third estimation model being a second update of the first estimation model, and
an inhibition module, the inhibition module being able to inhibit reception by the analysis module of the prediction of at least one estimation module from among the first estimation module, the second estimation module and the third estimation module;
the coordination system is part of one of the estimation devices;
each estimation device is able to receive data acquired from a detection device;
the data acquired by the detection device are images or audio signals;
the physical magnitude characterizes the environment of the detection device, the physical magnitude being in particular the temperature or the presence and/or identification of an object in this environment;
the physical magnitude is a magnitude relating to a means of transport including the detection device, in particular a magnitude giving the trajectory of the means of transport;
the estimation device includes a sending module suitable for sending the estimate of the physical magnitude to be estimated to a control module, the control module being suitable for controlling a physical device as a function of the estimate of the physical magnitude to be estimated, in particular for modifying the operation of the physical device;
the physical device is a means of transport, in particular an aircraft.

The description also relates to a device for estimating a physical magnitude, the estimation device including:
a first estimation module, the first estimation module including:
a first receiving unit able to receive data acquired by a detection device, and
a first calculation unit able to apply a first estimation model to the data received by the first receiving unit to obtain a first prediction of the physical magnitude to be estimated,
a second estimation module, the second estimation module including:
a second receiving unit able to receive data acquired by a detection device, and
a second calculation unit able to apply a second estimation model to the data received by the second receiving unit to obtain a second prediction of the physical magnitude to be estimated, the second estimation model being an update of the first estimation model, and
an analysis module, the analysis module being able to analyze the consistency of values derived from the first prediction and the second prediction and to deduce from the consistency analysis an estimation of the physical magnitude to be estimated for the estimation device.

The description also relates to a device for estimating a physical magnitude, the estimation device including:
a first estimation module, the first estimation module including:
a first receiving unit able to receive data acquired by a detection device, and
a first calculation unit able to apply a first estimation model to the data received by the first receiving unit to obtain a first prediction of the physical magnitude to be estimated,
a second estimation module, the second estimation module including:
a second receiving unit able to receive data acquired by a detection device, and
a second calculation unit able to apply a second estimation model to the data received by the second receiving unit to obtain a second prediction of the physical magnitude to be estimated, the second estimation model being a first update of the first estimation model,
a third estimation module, the third estimation module including:
a third receiving unit able to receive data acquired by a detection device, and
a third calculation unit able to apply a third estimation model to the data received by the third receiving unit to obtain a third prediction of the physical magnitude to be estimated, the third estimation model being a second update of the first estimation model,
an analysis module, the analysis module being able to receive each prediction and to obtain an estimation of the physical magnitude to be estimated for the estimation device from the received predictions, and
an inhibition module, the inhibition module being able to inhibit reception by the analysis module of the prediction of at least one estimation module from among the first estimation module, the second estimation module and the third estimation module.

The description also relates to a system for estimating a physical magnitude, the system for estimating including:
several devices for estimating the physical magnitude, each estimation device including an analysis module, each analysis module being able to analyze the consistency of values derived from predictions obtained by applying at least two estimation models to data acquired by a detection device, one estimation model being an update of another estimation model, to obtain a value representative of the consistency between the predictions, and
a coordination system able to apply an aggregation function to the values representative of the consistency between the predictions to obtain an aggregated value and able to deduce an estimation of the physical magnitude to be estimated from the aggregated value.

The description also has as its object a method for estimating a physical magnitude, the estimation method being implemented by computer and including:
receiving data acquired by a detection device,
applying a first estimation model to the received data to obtain a first prediction of the physical magnitude to be estimated,
applying a second estimation model to the received data to obtain a second prediction of the physical magnitude to be estimated, the second estimation model being an update of the first estimation model,
analyzing the consistency of values derived from the first prediction and the second prediction, and
deducing from the consistency analysis an estimation of the physical magnitude to be estimated.

The description also relates to a method for estimating a physical magnitude including:
receiving data acquired by a detection device,
applying a first estimation model to the received data to obtain a first prediction of the physical magnitude to be estimated,
applying a second estimation model to the received data to obtain a second prediction of the physical magnitude to be estimated, the second estimation model being a first update of the first estimation model,
applying a third estimation model to the received data to obtain a third prediction of the physical magnitude to be estimated, the third estimation model being a second update of the first estimation model,
receiving each prediction, the reception of the prediction of at least one estimation module from among the first estimation module, the second estimation module and the third estimation module being inhibited by an inhibition module, and
obtaining an estimation of the physical magnitude to be estimated for the estimation device from the received predictions.

The description also relates to a method for estimating a physical magnitude, the estimation method being implemented by computer and including:
obtaining values representative of the consistency between the predictions of several devices for estimating the physical magnitude by analyzing the consistency of values derived from predictions obtained by applying at least two estimation models to data acquired by a detection device, one estimation model being an update of another estimation model,
applying an aggregation function to the values representative of the consistency between the predictions to obtain an aggregated value, and
deducing an estimation of the physical magnitude to be estimated from the aggregated value.

In the present description, the expression “able to” means indiscriminately “adapted for”, “adapted to” or “configured for”.

### BRIEF DESCRIPTION OF THE DRAWINGS

The invention will appear more clearly on reading the following description, given solely by way of non-limiting example and made with reference to the drawings in which:

FIG. 1 is a schematic representation of an example of a system for estimating a physical magnitude including a detection device and an estimation device;

FIG. 2 is a representation of the operation of the units of the estimation device of FIG. 1;

FIG. 3 is a flowchart of an example of implementation of an estimation method by the system for estimating of FIG. 1;

FIG. 4 is a schematic representation of another example of a system for estimating a physical magnitude including a detection device and an estimation device;

FIG. 5 is a representation of an example of operation of the units of the estimation device of FIG. 4;

FIG. 6 is a flowchart of an example of implementation of an estimation method by the system for estimating of FIG. 4;

FIG. 7 is a schematic representation of an example of a system for estimating a physical magnitude including a coordination system;

FIG. 8 is a flowchart of an example of implementation of an estimation method by the system for estimating of FIG. 7;

FIG. 9 is a schematic representation of another example of a system for estimating a physical magnitude including a coordination system; and

FIG. 10 is a schematic representation of yet another example of a system for estimating a physical magnitude including a coordination system.

### DETAILED DESCRIPTION OF THE INVENTION

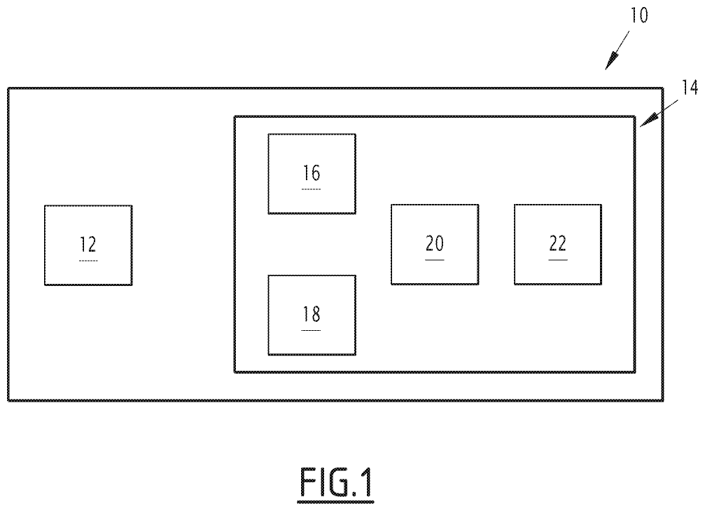

A system for estimating 10 is illustrated in FIG. 1.

The system for estimating 10 is able to estimate a physical magnitude.

The physical magnitude may be of any type, the system for estimating 10 thus serving as a measurement system.

According to one particular example, the system for estimating may be viewed as an environmental observation system.

The system for estimating 10 includes a detection device 12 and an estimation device 14.

The detection device 12 is able to acquire data.

For this purpose, the detection device 12 includes one or more sensors able to collect data.

The collected data are thus measurements.

According to the described example, the detection device 12 is a camera, the camera providing images.

The data acquired by the detection device 12 are thus images.

As an alternative or in addition, the detection device 12 may include any type of sensors, and notably sensors able to collect signals of audio, video, time-series, tabular data or any other type of signals.

The estimation device 14 is a device for estimating a physical magnitude.

The estimation device 14 is able to apply processing operations to data acquired by the detection device 12 to obtain an estimated value, which corresponds to the value of the sought physical magnitude.

These processing operations involve applying an estimation model to data acquired by the detection device 12.

The estimation model is a model resulting from artificial intelligence and notably a model obtained by machine learning.

By way of non-limiting example, the estimation model is a neural network.

The estimation model is able to provide an estimated value of the physical magnitude over the predefined ODD domain of use.

The predefined domain of use is, by definition, the set of operating conditions in which the estimation model is specifically designed to operate, including, but not limited to, environmental, geographical and temporal restrictions.

In the present context, the estimation model is a model intended to evolve over time.

This evolution may have several causes.

For example, the performance of the estimation model is insufficient, the estimation model must perform a different or additional task, or the evaluation criteria of the estimation model change (according to a particular case due to regulatory changes).

Such an evolution of the model is generally obtained by retraining on a new increment of data and the associated activities of incremental qualification under constraints (that is, an incomplete manner).

This corresponds to incremental learning implying that the estimation model will have several versions.

As will appear below, the estimation device 14 here allows to use two successive versions of the estimation model, a first version before update and a second version after update, having been qualified under constraints.

To illustrate this clearly, a specific estimation model that is a classifier is considered.

The estimation device 14 includes a first estimation module 16, a second estimation module 18, an analysis module 20 and a warning module 22.

The first estimation module 16 is able to obtain a first prediction and a first value representative of the confidence in this prediction from data acquired by the detection device 12.

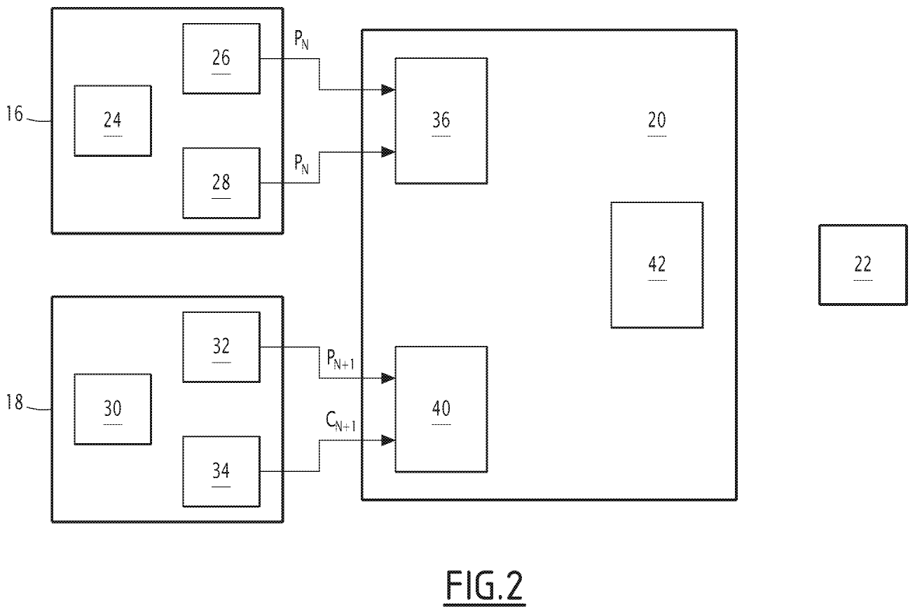

In FIG. 2, the first prediction is denoted P_{N} whereas the first value representative of the confidence is denoted C_{N}.

The first estimation module 16 includes a first receiving unit 24, a first calculation unit 26 and a first determination unit 28.

The first receiving unit 24 is configured to receive the data acquired by the detection device 12.

The first calculation unit 26 is able to apply a first estimation model to the data received by the first receiving unit 24 to obtain the first prediction P_{N}.

The first estimation model is here assumed to be version N, N being an integer greater than or equal to 1.

As a result, the first estimation model is denoted ME_{N} and therefore corresponds here to the estimation model before the update (here the Nth one).

To simplify the notation, the first estimation model will simply be denoted estimation model ME_{N}.

An estimation model that would be able to classify the input data according to three output classes, a first class, a second class and an anomaly class is considered.

The anomaly class corresponds to abnormal data.

In such a case, this implies that the estimation model taking an abnormal datum as input must, in normal operation, interpret such a datum as an anomaly. Typically, the estimation model will output an error code or a classification of the abnormal datum as being, for example, unknown data.

More specifically, it is assumed that the estimation model ME_{N} is a recognition model able to identify, in the observed environment, two elements, hereinafter referred to as element A (first class) and element B (second class). Any other element is not recognized by the estimation model ME_{N} (anomaly class).

The first prediction P_{N} is therefore element A, element B or anomaly.

The first determination unit 28 is able to determine a first value representative of the confidence in the prediction of the first calculation unit 26.

For example, the first determination unit 28 applies a function able to provide the confidence knowing the estimation model ME_{N} and the first prediction P_{N}.

According to another example, the first determination unit 28 uses the estimation model ME_{N}. In such a case, the first calculation unit 26 and the first determination unit 28 may be combined, the estimation model ME_{N} then being able to provide as output the first prediction P_{N} and the first value representative of the confidence C_{N} in the prediction of the first calculation unit 26.

The first value representative of the confidence in the prediction of the first calculation unit 26 is notably expressed in the form of a probability, without this example being limiting.

The second estimation module 18 is able to obtain a second prediction and a second value representative of the confidence in this prediction from data acquired by the detection device 12.

In FIG. 2, the second prediction is denoted P_{N+1} while the second value representative of the confidence is denoted C_{N+1}.

The second estimation module 18 includes a second receiving unit 30, a second calculation unit 32 and a second determination unit 34.

The second receiving unit 30 has the same role as the first receiving unit 24.

In one embodiment, the first receiving unit 24 and the second receiving unit 30 are combined.

The second calculation unit 32 is able to apply a second estimation model to the data received by the second receiving unit 30 to obtain the second prediction P_{N+1}.

The second estimation model corresponds to the update of the first estimation model ME_{N}, here by implementation of incremental learning.

In other words, the second estimation model corresponds to the version (or increment) N+1 of the estimation model.

As a result, the second estimation model is denoted ME_{N+1} and will therefore be referred to below as the estimation model ME_{N+1} to simplify the notation.

In the described example, it is assumed that the update aims to obtain an estimation model ME_{N+1}, able to identify, in the observed environment, two elements, hereinafter referred to as element C (first class) and element B (second class). Any other element is not recognized by the estimation model ME_{N+1} (anomaly class).

Element C is different from element A that the estimation model ME_{N} is able to recognize.

The second determination unit 34 is able to determine a second value representative of the confidence C_{N+1} in the prediction of the second calculation unit 32.

Remarks similar to those concerning the first determination unit 28 are also valid here and are not repeated for the sake of conciseness.

The analysis module 20 is able to receive the outputs of the estimation modules 16 and 18 and to select the best estimation of the physical magnitude to be estimated.

According to the described example, the analysis module 20 is able to analyze the outputs of the estimation modules 16 and 18 to obtain the best prediction as output.

More specifically, according to the illustrated example, to obtain the best prediction, the analysis module 20 takes as input the various predictions P_{N} and P_{N+1} and the confidence scores C_{N} and C_{N+1} and emits as output a predicted value for the warning device 22. This predicted value is specified below.

As represented in FIG. 2, the analysis module 20 includes a first consolidation unit 36, a second consolidation unit 40 and a verification unit 42.

The first consolidation unit 36 is able to consolidate the first prediction P_{N} of the first estimation module 16.

For this purpose, the first consolidation unit 36 is able to obtain such a first consolidated prediction PC_{N} as a function of a confidence criterion depending on the first confidence value C_{N}.

According to the described example, the performance criterion is a comparison with a threshold.

The first consolidation unit 36 compares the first confidence value C_{N} with a predefined threshold S_{N}.

The predefined threshold S_{N} is, for example, provided with the estimation model ME_{N}, this value being determined during training of the estimation model ME_{N} as a function of the performance thereof on a test dataset.

When the first confidence value C_{N} is greater than or equal to the threshold, the first consolidation unit 36 emits as output a first consolidated prediction PC_{N} which is equal to the first prediction P_{N} of the first estimation module 16.

Conversely, when the first confidence value C_{N} is strictly less than the threshold, the first consolidated prediction PC_{N} is the anomaly class (independent of the value of the first prediction P_{N}).

The second consolidation unit 40 functions in a similar manner to the first consolidation unit 36 for the second prediction P_{N+1.}

Thus, when the second confidence value C_{N+1} is greater than or equal to a predefined threshold S_{N}+1, the second consolidation unit 40 emits as output a second consolidated prediction PC_{N+1} which is equal to the second prediction P_{N+1} of the second estimation module 18.

Conversely, when the second confidence value C_{N+1} is strictly less than the predefined threshold S_{N}+1, the second consolidated prediction PC_{N+1} is the anomaly class (independent of the value of the second prediction P_{N+1}).

The verification unit 42 is a unit for verifying the consistency between the consolidated predictions PC_{N} and PC_{N+1} of the two consolidation units 36 and 40.

The verification unit 42 is able to compare the values of the two consolidation units 36 and 40 and to deduce a verified prediction PV as a function of the result of the comparison.

According to one embodiment, the verification unit 42 uses a truth table to carry out the comparison and deduction actions.

The truth table is a function taking as input the value of the first consolidated prediction PC_{N} and the value of the second consolidated prediction PC_{N+1} and giving as output the verified prediction PV.

TABLE 1 below gives the truth table used by the verification unit 42 for the described example with the two estimation models ME_{N} and ME_{N+1}.

| First | Second | | |
|---|---|---|---|
| consolidated | consolidated | Result of | |
| prediction | prediction | the | Verified |
| PC_{N} | PC_{N+1} | comparison | prediction PV |
| Element A | Element C | Disagreement | Output of |
| | | | model |
| | | | ME_{N} (element |
| | | | A) |
| Element A | Element B | Disagreement | Output of |
| | | | model |
| | | | ME_{N} (element |
| | | | A) |
| Element A | Unrecognized | Agreement | Output of |
| | (neither C nor | | model |
| | B) | | ME_{N+1} |
| | | | (neither C nor |
| | | | B) |
| Element B | Element C | Disagreement | Output of |
| | | | model |
| | | | ME_{N} (element |
| | | | B) |
| Element B | Element B | Agreement | Output of |
| | | | model ME_{N+1} |
| | | | (element B) |
| Element B | Unrecognized | Disagreement | Output of |
| | (neither C nor | | model |
| | B) | | ME_{N} (element |
| | | | B) |
| Unrecognized | Element C | Agreement | Output of |
| (neither A nor | | | model ME_{N+1} |
| B) | | | (element C) |
| Unrecognized | Element B | Disagreement | Output of |
| (neither A nor | | | model |
| B) | | | ME_{N} |
| | | | (neither A nor |
| | | | B) |
| Unrecognized | Unrecognized | Agreement | Output of |
| (neither A nor | (neither C nor | | model ME_{N+1} |
| B) | B) | | (neither C nor |
| | | | B) |

It follows from the analysis of the preceding table that, when the first consolidated prediction PC_{N} and the second consolidated prediction PC_{N+1} are inconsistent, the analysis module 20 is able to deduce that the value of the estimation of the physical magnitude is the first consolidated prediction PC_{N}.

Conversely, when the first consolidated prediction PC_{N} and the second consolidated prediction PC_{N+1} are consistent, the analysis module 20 is able to deduce that the value of the estimation of the physical magnitude is the second consolidated prediction PC_{N+1.}

In this embodiment, the absence of consistency between the two estimation models ME_{N} and ME_{N+1} is thus the sign that the estimation model ME_{N+1} is not sufficiently reliable.

This is how the analysis module 20 analyzes the consistency of values derived from the first prediction P_{N} and the second prediction P_{N+1} and deduces therefrom an estimation of the physical magnitude to be estimated.

The warning module 22 is able to emit an alert in the event of temporal persistence of a disagreement at the output of 42 (disagreement between the predictions of the two estimation models ME_{N} and ME_{N+1}).

To evaluate the existence of temporal persistence, the warning module 22 analyzes the number of disagreements over a set of comparisons carried out by the verification unit 42.

According to one example, the warning module 22 accumulates the results of the comparisons and applies a persistence criterion to at least part of the results thus accumulated to determine whether it should emit a warning or not.

According to a simple example, when this number of results exceeds a threshold K, the warning module 22 implements, for example, a synthesis technique such as that described below. K is here a natural integer strictly greater than 1.

The threshold K is configurable, so that the warning model performs a synthesis over a configurable sliding window.

More specifically, for comparisons k to k-K (k being an integer greater than or equal to K), the number of disagreements is compared with a threshold, exceeding the threshold leading to the emission of an alarm by the warning module 22.

Alternatively, it is possible to consider the percentage of disagreements instead of the number of disagreements.

It is also possible to consider verifying only the consolidated results.

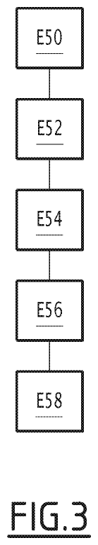

In operation, the system for estimating 10 thus implements an estimation method for a physical magnitude, for example as described with reference to FIG. 3.

The method includes a receiving operation E50, a first application operation E52, a second application operation E54, an analysis operation E56 and a deduction operation E58.

During the receiving operation E50, the data acquired by a detection device 12 are received by the first estimation module 16 and the second estimation module 18.

During the first application operation E52, the first calculation unit 26 applies the estimation model ME_{N} to the received data to obtain the first prediction P_{N} of the physical magnitude to be estimated.

During the second application operation E54, the second calculation unit 32 applies the estimation model ME_{N+1} to the received data to obtain the second prediction P_{N+1} of the physical magnitude to be estimated.

The two application operations E52 and E54 may be implemented in parallel, potentially with synchronization constraints depending on the applications.

During the analysis operation E56, the analysis module 20 analyzes the consistency of values derived from the first prediction P_{N} and the second prediction P_{N+1.}

In this case, the values derived from the first prediction P_{N} and the second prediction P_{N+1} are the consolidated values PC_{N} and PC_{N+1.}

During the deduction operation E58, the analysis module 20 deduces from the consistency analysis an estimation of the physical magnitude to be estimated.

For this purpose, the analysis module 20 applies, for example, the preceding truth table.

The estimation device 14 is thus able to perform monitoring of the update of an estimation model ME by comparing the predictions between the estimation model ME_{N} (before the update) and the estimation model ME_{N+1} (after the update).

More specifically, the estimation device 14 monitors the new estimation model ME_{N+1} during inference using the predictions of the estimation model ME_{N}. This monitoring takes the form of a comparison of their inputs and/or their internal states and/or their outputs in real time, and of a deduction of a consolidated prediction on the datum seen during inference.

This comparison is here carried out by the verification unit 42 on the basis of a truth table.

The truth table is here to be understood in the sense of a comparison and consolidation logic.

In this sense, the estimation device 14 corresponds to a two-path architecture allowing both to implement two estimation models (here the models ME_{N} and ME_{N+1}) and to control this implementation.

In addition, this allows to drastically minimize the development costs of a monitoring solution because the addition of the increment itself will facilitate this process via the use of at least the consistency analysis, possibly supplemented by temporal persistence logic (performed by the warning module 22).

The estimation device 14 therefore allows to effectively detect novelties and drifts, which allows to increase confidence in the estimation model. The estimation device 14 thus provides a solution to the problem of qualification and user confidence in its system for estimating 10 in the context of updates of the estimation model used.

The estimation device 14 does not imply specifically developing a dedicated monitoring tool, which may be costly since it uses only the two estimation models to compare them and notably to verify that the new estimation model ME_{N+1} indeed meets the new requirements as well as the old requirements (those of the estimation model ME_{N}) that are still valid while no longer meeting the abandoned old requirements. The estimation device 14 may also verify in certain cases that the predefined domain of use of the estimation model ME_{N+1} is indeed preserved when this is relevant.

In the example that has just been described, the first estimation module 16, the second estimation module 18, the analysis module 20 and the warning module 22 are each realized in the form of software, or a software and/or hardware block (for example, FPGA), executable by the processor.

The memory of the estimation device 14 is then able to store a first estimation software program, a second estimation software program, an estimation software program and a warning software program. The processor is then able to execute each of the software programs from among the first estimation software program, the second estimation software program, the estimation software program and the warning software program.

All these units may be developed using software technologies such as assembly, C++, Java, C, RUST, Go or Python. The choice of programming language will be defined by the level of criticality of the use of the system for estimating 10 and/or the desired performance.

The platform on which these units will be executed will depend on the use case. It may be a simple traditional server or a station with graphic processing units (GPU) locally or in edge computing, or a distributed platform.

In one alternative, not represented, the first estimation module 16, the second estimation module 18, the analysis module 20 and the warning module 22 are each realized in the form of a programmable logic component, such as an FPGA (Field Programmable Gate Array), or else an integrated circuit, such as an ASIC (Application Specific Integrated Circuit).

When the estimation device 14 is realized in the form of one or more software programs, in other words, in the form of a computer program, also called a computer program product, it is further able to be recorded on a computer-readable medium, not represented. The computer-readable medium is for example a medium able to store electronic instructions and to be coupled to a bus of a computer system. By way of example, the readable medium is an optical disk, a magneto-optical disk, a ROM memory, a RAM memory, any type of non-volatile memory (for example FLASH or NVRAM) or a magnetic card. A computer program including software instructions is then stored on the readable medium.

These remarks relative to the physical implementation of the first estimation module 16, the second estimation module 18, the analysis module 20 and the warning module 22 are also valid for the units contained in these modules.

Other embodiments of the estimation device 14 are possible.

In particular, it is possible to consider simpler implementations of the estimation device 14. It could, for example, use a simple comparison of the predictions P_{N} and P_{N+1.}

It is also possible to directly use the values representative of the confidence C_{N} and C_{N+1} in the verification unit 42, which allows to avoid using the two consolidation units 36 and 40.

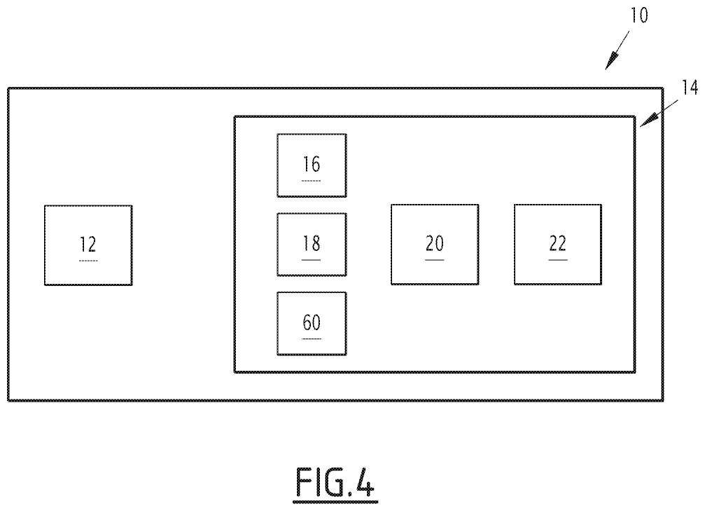

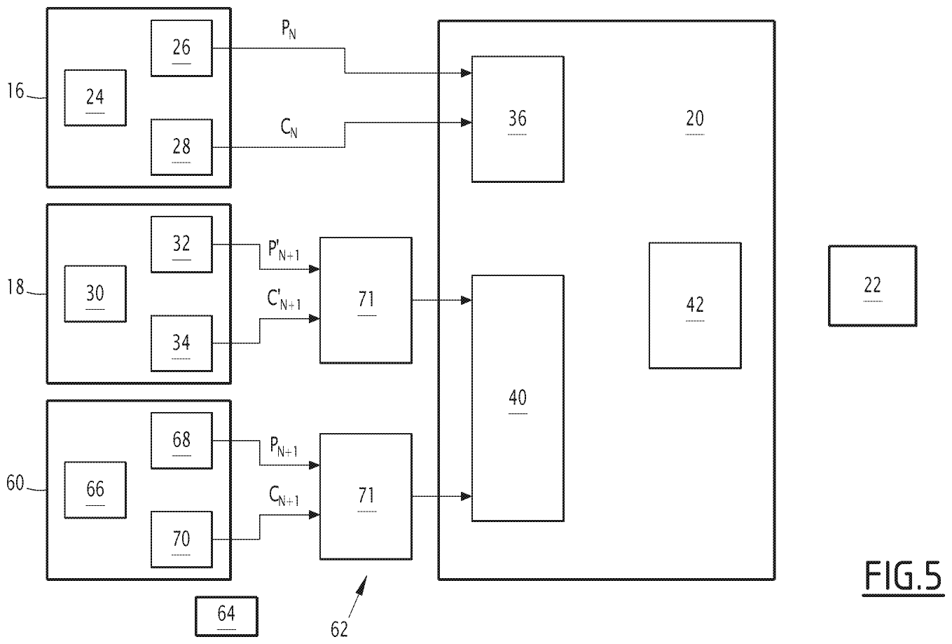

A system for estimating 10 according to another embodiment is also illustrated in FIGS. 4 and 5.

The system for estimating 10 includes the same elements as the system for estimating 10 of FIGS. 1 and 2.

In particular, the estimation device 14 according to FIG. 3 includes the first estimation module 16, the second estimation module 18, the analysis module 20 and the warning module 22.

Relative to the preceding example, the second calculation unit 32 applies a second estimation model which is an intermediate version between the Nth version of the estimation model ME_{N} applied by the first calculation unit 26 and the (N+1)th version of the estimation model ME_{N+1.}

To avoid confusion, the second estimation model will be denoted using the notation ME′_{N+1}. The predictions and confidence values will also be denoted with a “′” in the form P′_{N+1} and C′_{N+1}.

The system for estimating 10 also includes a third estimation module 60, an inhibition module 62 and a control module 64.

The third estimation module 60 includes a third receiving unit 66, a third calculation unit 68 and a third determination unit 70.

The third receiving unit 66 has the same role as the first receiving unit 24 or the second receiving unit 30.

In one embodiment, the first receiving unit 24, the second receiving unit 30 and the third receiving unit 66 are combined.

The third calculation unit 68 is able to apply a third estimation model to the data received by the third receiving unit 66 to obtain a third prediction P_{N+1.}

The third estimation model corresponds either to a second update of the first estimation model ME_{N} or to an update of the estimation model ME′_{N+1}, here by implementation of incremental learning.

The second update is different from the first update.

In other words, in the described example, the third estimation model corresponds to the version (or increment) N+1 of the estimation model.

As a result, the third estimation model is denoted ME_{N+1} and will therefore be referred to below as the estimation model ME_{N+1} to simplify the notation.

The third determination unit 70 is able to determine a third value representative of the confidence C_{N+1} in the prediction of the third calculation unit 68.

In one embodiment, the second determination unit 34 and the third determination unit 70 are combined.

The inhibition module 62 is able to inhibit reception by the analysis module 20 of the prediction of at least one estimation module from among the first estimation module 16, the second estimation module 18 and the third estimation module 60.

By inhibit, it is understood here “prevent” or “interrupt” according to the operation chosen for the inhibition module 62. An example for each of these two definitions will be given later in the description.

According to the described example, the inhibition module 62 is able to inhibit only reception of the prediction P′_{N+1} from the second estimation module 18 or the prediction P_{N+1} from the third estimation module 60.

This implies that the estimation device 14 always has the first prediction P_{N}, this prediction serving in this context as the reference prediction.

Furthermore, the inhibition module 62 presents two states.

In such a case with only two states, the inhibition module 62 may be considered as a switching module insofar as the inhibition module 62 allows to switch between the prediction of the second estimation module 18 and the prediction of the third estimation module 60.

The first state is a state of the inhibition module 62 in which only reception of the prediction from the second estimation module 18 is inhibited. In other words, the first state is an inhibition state of the second estimation module 18.

The second state is a state of the inhibition module 62 in which only reception of the prediction from the third estimation module 60 is inhibited. The second state is thus an inhibition state of the third estimation module 60.

An example of the physical embodiment of the inhibition module 62 is given by way of illustration in FIG. 5.

In this example, the inhibition module 62 includes an inhibition unit 71 for each estimation module 18 and 60 the inhibition module 62 of which is able to inhibit reception of the prediction by the analysis module 20.

For example, the inhibition unit 71 is a switch presenting an open position in which reception of the prediction by the analysis module 20 is inhibited and a closed position in which reception of the prediction by the analysis module 20 is not inhibited.

The control module 64 is able to control the state of the inhibition module 62, that is to say to send it a command to switch to one state from among the preceding states.

According to one particular example, the control module 64 is able to cause the implementation of a loading operation of the third estimation model ME_{N+1} onto the third calculation unit 68.

For this purpose, the control unit 64 is able to interact with an external device to be informed of the availability of the estimation model ME_{N+1} and obtain this model.

Obtaining such is generally implemented by on-the-fly downloading.

This implies that the system for estimating 10 is also provided with a remote download unit (transmitter/receiver) for the weights of the estimation model that is reliable, efficient and secure. Access to a memory storing the weights for reading and writing is also used.

In such a case, the control module 64 applies a control law to the inhibition module 62 having the effect that the inhibition module 62 is in the first state when the loading operation has not been implemented and in the second state when the loading operation has taken place.

This allows for the analysis module 20 to have the most up-to-date version of the estimation model, namely first the intermediate estimation model and then the estimation model ME_{N+1} when the latter is available.

The analysis module 20 then operates as before, the predictions and confidence values received being those coming from the first estimation module 16 as well as either those from the second estimation module 18 or that from the third estimation module 60.

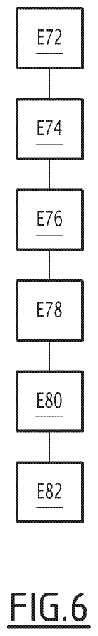

An example of operation of the system for estimating 10 of FIGS. 4 and 5 is now described with reference to FIG. 6, which illustrates an example of implementation of an estimation method of a physical magnitude by this system for estimating 10.

The estimation method includes a first receiving operation E72, a first application operation E74, a second application operation E76, a third application operation E78, a second receiving operation E80 and an obtaining operation E82.

During the first receiving operation E72, the data acquired by a detection device 12 are received by the first estimation module 16, the second estimation module 18 and the third estimation module 60.

During the first application operation E74, the first calculation unit 26 applies the estimation model ME_{N} to the received data to obtain the first prediction P_{N} of the physical magnitude to be estimated.

During the second application operation E76, the second calculation unit 32 applies the estimation model ME′_{N+1} to the received data to obtain the second prediction P′_{N+1} of the physical magnitude to be estimated.

During the third application operation E78, the third calculation unit 60 applies the estimation model ME_{N+1} to the received data to obtain the third prediction P_{N+1} of the physical magnitude to be estimated.

The application operations E74, E76 and E78 may be implemented simultaneously.

During the second receiving operation E80, the analysis module 20 receives exactly two predictions systematically including reception of the prediction of the first estimation module 16, and reception of one prediction from among the second estimation module 18 or the third estimation module 60, the other being inhibited by an inhibition module 62.

During the obtaining operation E82, the analysis module 20 obtains an estimation of the physical magnitude to be estimated for the estimation device 14 from the received predictions.

Such an obtaining operation E82 is, for example, implemented by a consistency analysis as described above.

Such a general operation may be used for several different use cases.

A first example has been given for the case of downloading the estimation model ME_{N+1} during use. The intermediate estimation model ME′_{N+1} is then used for lack of having the estimation model ME_{N+1}, notably because its training takes too much time.

This allows to ensure continuity for use of the estimation model insofar as the updated estimation models are made available continuously and the transition from one version of the estimation model to another version is easy since it does not imply interruption of use (shutdown and restart avoided).

According to a second example, the intermediate estimation model ME′_{N+1} presents a major safety problem, and it may thus be considered to update the intermediate estimation model ME′_{N+1} to remedy the identified major problem.

In such a case, the intermediate update would relate only to the values of the weights while preserving the rest of the neural network architecture (for example, same number of neurons, same number of layers, identical operators). Thus, a small adjustment is carried out (more often referred to by the corresponding English term “fine tuning”).

This allows only to have to load the weights of the estimation model. This technique may also be used for loading version N+1 of the estimation model ME_{N+1.}

Indeed, such a technique is compatible with embedded constraints where resources are limited.

Through these non-limiting examples, it appears that the system for estimating 10 allows to carry out development and qualification on incremental learning of an estimation model with relaxed constraints.

For this purpose, the system for estimating 10 proposes a three-path architecture allowing to implement and monitor a version N of the estimation model, an intermediate version of the estimation model and a version N+1 of the estimation model (for example obtained by a patch loaded on the fly).

The system for estimating 10 thus takes advantage of the time of use to continue qualification of the version N+1 (carried out under constraints) and thus have a version N+1 that is as robust and as mature and stable as possible.

Other embodiments are also possible.

In particular, it is possible to mutualize the components of the second estimation module 18 and of the third estimation module 60.

For example, the determination unit that is able to determine the values representative of the confidence in the prediction may be shared, the inhibition module 62 then being positioned upstream of this common determination unit.

An inhibition module 62 may also be considered that is positioned in such a way as to prevent sending data to the calculation unit that the inhibition module 62 wishes to inhibit.

Each of the observation systems 10 that have just been described may be used in a collaborative context.

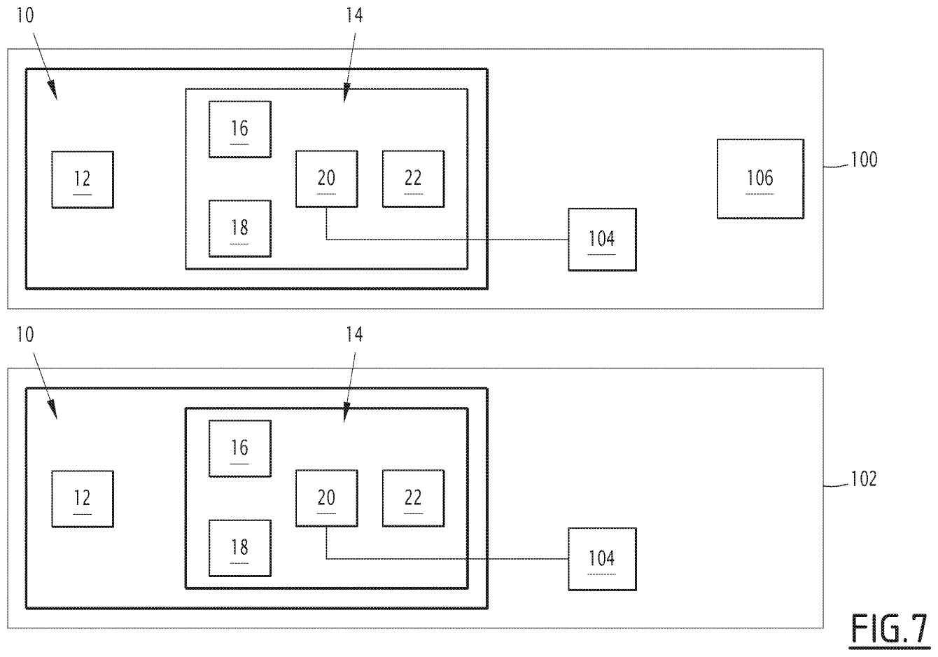

Such a case is schematized in FIG. 7 in which two sets 100 and 102 are represented.

A set is here a carrier, typically a drone, a fighter aircraft, a transport aircraft, a tanker or a surveillance aircraft.

Each set 100 or 102 includes a system for estimating 10 and a communication system 104 allowing to communicate with the other set 100 or 102.

The observation systems 10 are either (i) homogeneous, that is, of the same type, either according to the first example of FIG. 2 or according to the second example of FIG. 3, or (ii) heterogeneous combining the two examples.

Each communication system 104 is configured to exchange information between each set 100 or 102.

In the described example, the information is values representative of the consistency between the predictions of the estimation models used by each system for estimating 10.

More specifically, in the case of FIG. 7, the information is the results of the comparisons of the verification units 42 of each system for estimating 10.

The first set 100 further includes a coordination system 106.

The coordination system 106 is, for example, a computer.

The coordination system 106 is configured to obtain, via interactions with the communication systems 104, the results of the comparisons of the verification units 42 of each system for estimating 10.

The coordination system 106 then applies an aggregation function to the values representative of the consistency between the predictions to obtain an aggregated value.

In general, the aggregation functions are mathematical operations which allow to combine values to obtain a final value.

According to one particular example, the aggregation function is a majority vote.

This vote may be weighted, for example by taking into account the fact that one set may be better positioned to observe the environment and therefore that, a priori, its prediction is more reliable.

Alternatively, the aggregation function is a fuzzy logic function.

According to another embodiment, the aggregation function is a statistical function, notably by calculating performance statistics as a function of the task performed by the estimation model.

The coordination system 106 is able to deduce an estimation of the physical magnitude to be estimated from the aggregated value.

By way of example for the described case, the coordination system 106 implements the deduction according to the following truth table.

| | | Coordination | |
|---|---|---|---|
| Result for | Result for | aggregation | Deduced |
| the set 100 | the set 102 | system 106 | prediction |
| Disagreement | Disagreement | Disagreement | Output of |
| | | | model ME_{N} |
| Disagreement | Agreement | Disagreement | Output of |
| | | | model ME_{N} |
| Agreement | Disagreement | Disagreement | Output of |
| | | | model ME_{N} |
| Agreement | Agreement | Agreement | Output of |
| | | | model ME_{N+1} or |
| | | | ME′_{N+1} |

The coordination system 106 is then able to share with each system for estimating 10 a consolidated recommendation based on an overall consistency status which indicates the estimation of the physical magnitude to be used by each estimation device 14.

For this purpose, the coordination system 106 includes a communication unit (not represented) able to communicate with each of the communication systems 104.

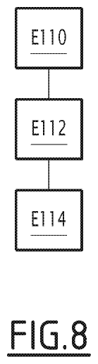

The associated operation corresponds to the flowchart schematized in FIG. 8.

The estimation method includes an obtaining operation E110, an application operation E112 and a deduction operation E114.

During the obtaining operation E110, each analysis module 20 analyzes the consistency of values derived from predictions obtained by applying the estimation models to data acquired by a detection device 12, one estimation model being an update of another estimation model, to obtain a value representative of the consistency between the predictions.

During the application operation E112, the coordination system 106 applies an aggregation function to the values representative of the consistency between the predictions to obtain an aggregated value.

During the deduction operation E114, the coordination system 106 deduces an estimation of the physical magnitude to be estimated from the aggregated value.

The estimation method that has just been described allows to add collective-type consolidation logic.

This allows to increase the reliability of the prediction.

The system for estimating 10 therefore allows to benefit from the simultaneous presence of several sets 100 and 102 to consolidate the prediction, which allows to increase the reliability of the simultaneous use of the two estimation models ME_{N} and ME_{N+1} or ME_{N} and ME′_{N+1.}

Other embodiments are possible.

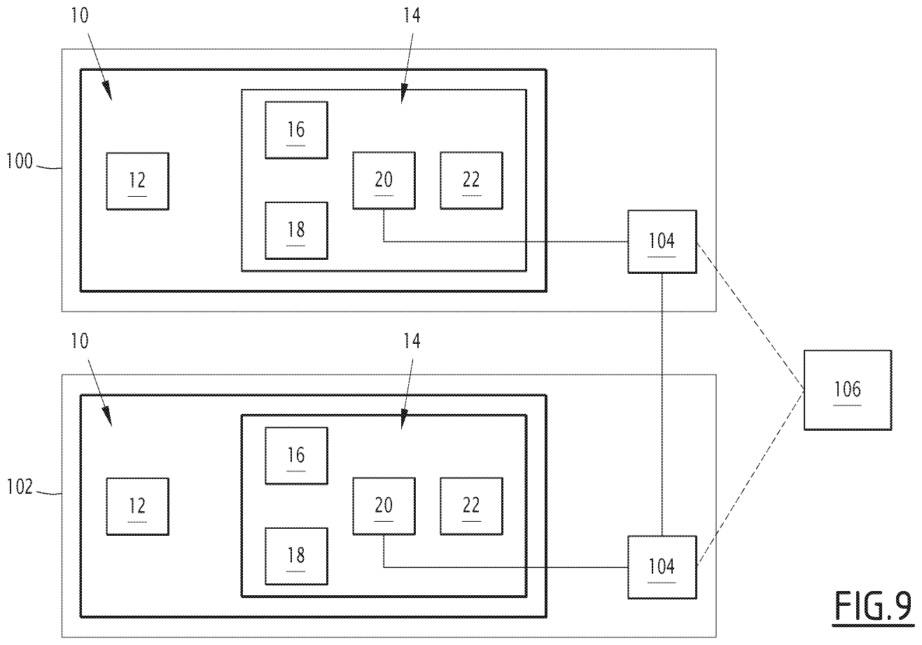

In particular, with reference to FIG. 9, the coordination system 106 may be a central system positioned at a distance from each of the sets 100 and 102.

The coordination system 106 remains in contact with each of the communication systems 104.

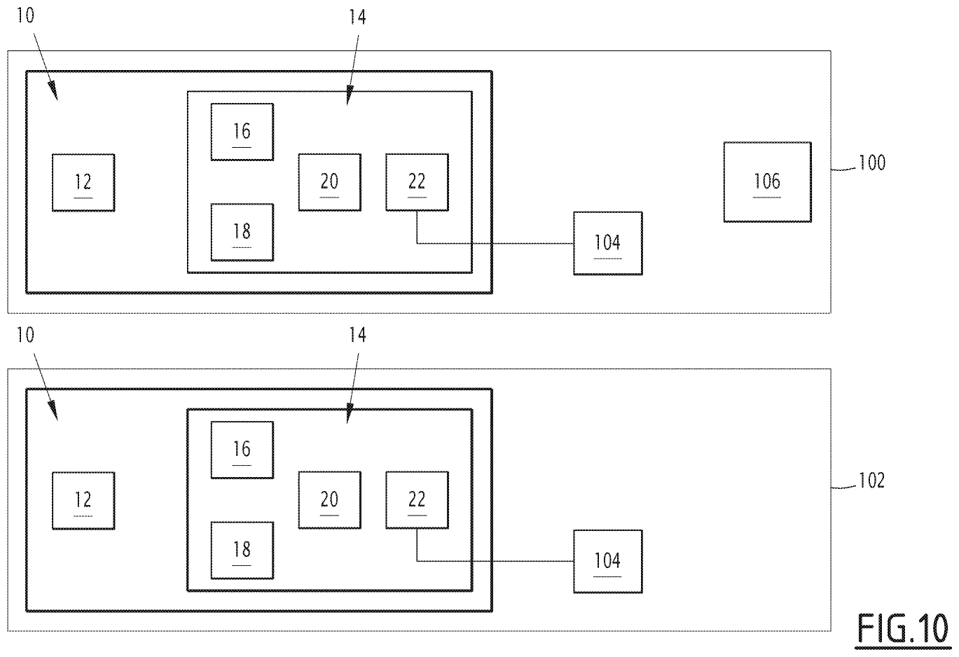

As an alternative or in addition, as schematized in FIG. 10, the values representative of the consistency between the predictions of the estimation models are the values obtained by the warning modules 22.

Typically, the coordination system 106 will use the percentage of disagreement of each warning module 22 to deduce therefrom the common prediction for each system for estimating 10.

More broadly, each warning module 22 is able to obtain a value representative of the temporal evolution of the results of the consistency analysis and the values representative of the consistency between the predictions are these values representative of the temporal evolution.

By way of an advantageous example, it may be considered to use in cascade an individual consistency status (denoted by the acronym SIC), an individual collaborative consistency status (denoted by the abbreviation SICC) and a persistent collaborative consistency status (SPCC). This allows to combine two consolidations, a consolidation between collaborative units (SICC) and a temporal consolidation (SPCC).

This may be illustrated for a case with two units by the following table:

| Time | SIC unit 1 | SIC unit 2 | SICC | SPCC |
|---|---|---|---|---|
| 0 | agreement | disagreement | disagreement | |
| 1 | disagreement | agreement | disagreement | disagreement |
| . . . | agreement | agreement | agreement | disagreement |
| K − 1 | agreement | agreement | agreement | agreement |
| K | agreement | disagreement | disagreement | disagreement |

In this example, unit 1 is the master unit whereas unit 2 is the follower unit.

The extension to more than one follower unit is immediate since it suffices to add as many columns as there are follower units.

1. A system for estimating a physical magnitude, comprising:
several devices for estimating the physical magnitude, each estimation device comprising an analysis module, each analysis module analyzing consistency of values derived from predictions obtained by applying at least two estimation models to data acquired by a detection device, one estimation model being an update of another estimation model, to obtain a value representative of consistency between the predictions; and
a coordination system applying an aggregation function to the values representative of consistency between the predictions to obtain an aggregated value and inferring an estimation of the physical magnitude to be estimated from the aggregated value.

2. The system according to claim 1, wherein each said device further comprises a communication system, and said coordination system comprises a communication unit communicating the deduced estimation to each said communication system, the estimation of the physical magnitude by each said device being the estimation deduced by said coordination system.

3. The system according to claim 1, wherein the aggregation function is a majority vote.

4. The system according to claim 1, wherein, for each said analysis module, the values derived from each prediction are obtained from the value of the prediction and from a value representative of confidence in the prediction.

5. The system according to claim 1, wherein each said device comprises, for each prediction, a consolidation unit able to obtain a consolidated prediction from the prediction as a function of a respective confidence criterion applied to the value representative of confidence in the prediction, the values derived from each prediction, the consistency of which is verified by said analysis module being respectively the consolidated prediction.

6. The system according to claim 1, wherein each said device further includes a warning module able to obtain a value representative of temporal evolution of the results of the consistency analysis, the values representative of consistency between the predictions being the values representative of temporal evolution.

7. The system according to claim 1, wherein each said estimation device further includes:
a third estimation module, comprising:
a third receiving unit receiving data acquired by a detection device; and
a third calculation unit applying a third estimation model to the data received by said third receiving unit to obtain a third prediction of the physical magnitude to be estimated, the third estimation model being a second update of the first estimation model; and
an inhibition module inhibiting reception by said analysis module of the prediction of at least one estimation module from among the first estimation module, the second estimation module and the third estimation module.

8. The system according to claim 1, wherein said coordination system is part of one of said devices.

9. The system for estimating according to claim 1, wherein each said device is able to receive data acquired from a detection device.

10. A method for estimating a physical magnitude, implemented by a computer and comprising:
obtaining values representative of consistency between predictions of several devices for estimating the physical magnitude by analyzing consistency of values derived from predictions obtained by applying at least two estimation models to data acquired by a detection device, one estimation model being an update of another estimation model;
applying an aggregation function to the values representative of consistency between the predictions to obtain an aggregated value; and
deducing an estimation of the physical magnitude to be estimated from the aggregated value.
